(19) United States
(12) Patent Application Publication
(10) Pub. No.: US 2025/0212272 A1
(43) Pub. Date: Jun. 26, 2025

(54) METHOD FOR OPERATING A FIRST DEVICE OF A SCANNER SYSTEM, METHOD FOR OPERATING A SCANNER SYSTEM AND CORRESPONDING SCANNER SYSTEM

(71) Applicant: Workaround GmbH, München (DE)

(72) Inventors: Dhananjay Gundapu JAYAKRISHNAN, München (DE); Nikola BOJOVIC, München (DE); Sebastian PETRUCH, München (DE)

(21) Appl. No.: 18/989,018

(22) Filed: Dec. 20, 2024

(30) Foreign Application Priority Data
Dec. 22, 2023 (DE) 102023136509.6

(51) Int. Cl. H04W 76/14; G06K 7/10; G06K 7/14; H04W 76/30

(52) U.S. Cl. CPC H04W 76/14; G06K 7/10891; G06K 7/1413; H04W 76/30

(57) ABSTRACT

A method for operating a first device of a scanner system, the scanner system including a main device and a scanning device having a code reader, wherein the main device and the scanning device are wireless enabled. The method includes the first device searching for a second device of the scanner system that advertises for connections, in particular a scanning device of the scanner system, determining the received signal strength of signals received from the second device, comparing the received signal strength to a strength cut-off limit, and initiating a wireless connection with the second device if the signal strength exceeds the cut-off limit. Further, a method for operating a scanner system and a scanner system is provided.

### FIELD OF THE DISCLOSURE

The disclosure relates to a method for operating a first device of a scanner system, a method for operating a scanner system and a corresponding scanner system.

### BACKGROUND

Scanner systems having portable secondary devices, for example sensor modules, such as barcode scanners, or portable display units including screens are known, for example from DE 10 2020 106 369 and US 2021/014910 A1.

In such systems, the secondary devices, like scanning devices usually communicate with a main device, wherein the main device controls the flow of data to and from the secondary devices.

Usually, Bluetooth communication connections between the main device and the secondary device are used so that the secondary devices must be connected to the correct main device.

In particular in environments where many sensor systems are used, such as a logistics center or a production line where every worker wears such a part of such a scanner system, connecting the secondary devices modules to the correct main device is a major challenge. This problem is further increased if the secondary device has no means of receiving data or information form the main device prior to setting up the Bluetooth connection, for example is the input means, e.g. a code reader, of the second device is incompatible with all output means of the main device.

### SUMMARY

Thus, there is a need for a method of operating a scanner system or devices thereof in which the connection of secondary devices to the main device is possible in a simple and reliable manner.

There is provided a method of operating a first device of a scanner system, in particular a main device. The scanner system comprises a main device having a wireless communication module and a scanning device having a code reader and a wireless communication module. The method comprises the following by the first device:
searching for a second device of the scanner system, in particular a scanning device of the scanner system, that advertises for connections,
determining the received signal strength of signals received from the second device,
comparing the received signal strength to a strength cut-off limit, and
initiating a wireless connection with the second device if the signal strength exceeds the cut-off limit.

The inventors have realized that the signals exchanged between the scanning devices and the main device via the wireless communication modules prior to establishing the wireless connection can be used to avoid misconnections, i.e. the pairing of a scanning device with a main device that should have not been paired with one another.

To this end, the signal strength of the advertising signals is used as an indication of proximity by the device searching for other devices. The signal strength thus provides a criterion for selecting a device out of a plurality of advertising devices to connect to.

If the signal strength does not exceed the strength cut-off limit, a connection is in particular not initiated.

In particular, the wireless connection is a Bluetooth connection. For example, the Bluetooth low energy standard is used for the Bluetooth connection.

According to the Bluetooth standard, for example discoverable devices advertise for connections.

For example, the first device initiates the connection by sending the connection request to the second device.

The scanning device is in particular a dedicated device for reading codes and/or configured to automatically send information about the codes that have been read to the main device.

In an aspect, the wireless communication modules of the main device and of the scanning device are Bluetooth modules, wherein the wireless connection between the first device and the second devices is a Bluetooth connection established using a Bluetooth connection (e.g. “handshake”), using well established and secure protocols.

In an embodiment, the first device determines the received signal strengths of signals received from more than one second device, for example up to 100 or even 1000 second devices, and initiates a wireless connection only with the one of the more than one second device whose signals received by the first device have the highest signal strength. This behavior leads to very good results even in crowded environments. The aspect of selecting the second device based on the highest signal strength received is to be regarded as an aspect independent of the selection using a signal strength cut-off limit. Thus, it is an independent aspect that a wireless connection with the second device may be initiated even if the highest signal strength lies below the cut-off limit.

In another embodiment, the first device comprises a control unit, the control unit having stored therein or in a storage accessible by the control unit a test condition. The method further comprises in this embodiment:
receiving an advertising name from the second device by the first device,
comparing the received advertising name with at least one test condition by the first device, and
initiating a wireless connection with the second device if the received advertising name fulfills the at least one test condition and if the signal strength exceeds the cut-off limit.

For example, if the test condition is not met, no connection is initiated or a connection is initiated in response to a further trigger, in particular without determining the received signal strength of signals received from the second device, comparing the received signal strength to a strength cut-off limit, and initiating a wireless connection with the second device if the signal strength exceeds the cut-off limit. The trigger may be that the user selects the second device to establish a connection with using an interface, e.g. a touch-sensitive display, of the first device.

In order to provide an even more precise coupling, the control unit of the first device may have stored therein or in a storage accessible by the control unit a name identifier, wherein the test condition is based on the name identifier, in particular wherein the test condition requires that the name identifier is identical to the received advertising name, that the name identifier is included in the received advertising name, that the name identifier is included in the received advertising name at a specific position of the advertising name, and/or that the received advertising name follows a scheme defined in the name identifier.

The scheme defined in the name identifier may include a portion being a specific static character string, i.e. one of one or more predefined strings of characters. The scheme may include a portion indicating a range of allowed characters.

The first device may have received the name identifier from a system control unit of the scanner system or by an input of a user.

In an embodiment, the method comprises the following by the first device:
repeatedly determining the received signal strength of signals received from the second device and the time of reception,
determining, based on the received signal strength and the time of reception, whether the second device is closing in on the first device, and
initiating a wireless connection with the second device if it has been determined that the second device is closing in on the first device and if the signal strength exceeds the cut-off limit.

This way, the accuracy of coupling to the correct device is improved further.

In case of the use of a test condition, a wireless connection with the second device is, for example, initiated if the received advertising name fulfills the at least one test condition, if it has been determined that the second device is closing in on the first device, and if the signal strength exceeds the cut-off limit.

For improving user comfort, the method may comprise terminating the wireless connection automatically, if the first device and/or the second device, in particular the scanning device and/or the main device, does receive any activity request from another device or from the user for a predetermined period of time, is inserted into a charging station, is connected to a charging cable, a new second device, in particular a new scanning device is connected, scans a disconnect barcode, and/or the received signals strength of signals received from the second device, in particular the scanning device, coupled to the first device falls below a disconnect strength cut-off limit.

A disconnect barcode may be a barcode that includes, encoded therein, information and/or an instruction to the scanning device and/or the main device to terminate the wireless connection and/or to power down the scanning device.

In an aspect, upon or after automatic termination of the wireless connection, the first device discards information received from the second device during the wireless connection, in particular an advertising name, a name identifier and/or a static identifier, ensuring that the for the next connection, the second device may be chosen freely from a plurality of second devices and attempts to automatically reconnect to the same second device are avoided.

For above mentioned purpose, further a method for operating a scanner system is provided. The scanner system comprises a main device, having a wireless communication module and a scanning device having a wireless communication module, wherein the method comprises the actions of a first device as described above, the main device or the scanning device being the first device.

The scanning device or the main device may be the second device, respectively.

The features and advantages described with respect to the method for operating a first device also apply to the method for operating a scanner system and vice versa.

For example, the main device is the host of the wireless connection and the scanning device is the client of the wireless connection, saving resources for the scanning device.

In order to provide the best accuracy with a high coupling speed, the strength cut-off limit may be set manually or the strength cut-off limit may be determined automatically, in particular by a system control unit of the scanner system.

For example, the strength cut-off limit may be set manually or determined automatically for an entire fleet of scanning devices, for example all scanning devices used on the same premise.

The system control unit may receive values of the signal strengths and manual disconnection events right after pairing and may determine an optimal cut-off limit value based on the values of the signal strengths and manual disconnection events.

In an embodiment, the second device advertises for connections using an advertising name based on a characteristic of the second device, in particular its serial number, a part of its serial number and/or an identifier of the type of the second device, allowing the first device to couple selectively to second devices.

The advertising name may be determined by the second device on basis of the characteristic using a predefined scheme or a scheme received by the second device.

For allowing identification of the second device, in an embodiment, the method further comprises by the second device:
receiving a name identifier and/or an advertising name, and
advertising for connections using the received advertising name or an advertising name based on the received name identifier.

The advertising name may be determined by the second device on basis of the name identifier using a predefined scheme or a scheme received by the second device. The scheme may be the same scheme as defined in the name identifier.

The scheme, name identifier and/or advertising name may be received by the second device by scanning a code by the second device.

For improving user comfort, the method may comprise terminating the wireless connection automatically, if the scanning device and/or the main device does receive any activity request from another device or from the user for a predetermined period of time, is inserted into a charging station, is connected to a charging cable, a new scanning device is connected, scans a disconnect barcode, and/or the received signals strength of signals received from the second device, in particular the scanning device, coupled to the first device falls below a disconnect strength cut-off limit.

Further for above mentioned purpose, a scanner system is provided. The scanner system comprises a main device, having a wireless communication module and a scanning device having a wireless communication module, wherein the main device or the scanning device is configured to carry out the method as described above as the first device and/or wherein the scanner system is configured to carry out the method as described above.

The features and advantages described with respect to one or both methods also apply to the scanner system and vice versa.

In an aspect, the main device comprises an output means, in particular a display, wherein the code reader of the scanning device is incompatible with the output means of the main device, so that even incompatible devices may be coupled with one another.

Incompatible means in particular that the code reader is incapable of retrieving data and/or information from the output means. Data and/or information, in particular a name identifier or advertising name, cannot be communicated using the code reader and the output means of the main device.

For simplifying the scanner system, the main device and/or the scanning device may be bare of a display and/or bare of a connection to the internet.

In an embodiment, the scanning device is a wearable device and/or the main device is a smart device, in particular smart glasses, providing an easy to use scanner system.

Within this disclosure a wearable is, for example, a device that is designed to be attached to a piece of clothing and/or worn with it.

Thus, the scanning device may be worn on the body of a user.

The code reader, also called scan engine, is in particular an optical code reader configured to read machine-readable codes, like barcodes, two-dimensional codes, for example QR codes, data matrix codes or the like, or any other optical machine-readable code. It is also conceivable that the code reader is another type of code reader, for example for reading RFID-tags.

For improved comfort, the scanner system may comprise an article of clothing, in particular a glove, which is designed to attach the scanning device to the body of the user, in particular wherein the article of clothing has an actuating element which is connected to the scanning device such that it serves as an input means for the scanning device and/or can actuate the scanning device. This way, the scanning device may be used flexibly without being held in the hand.

To improve efficiency further, the scanning device may be worn on the body of a user.

In an aspect, upon or after automatic termination of the wireless connection, the first device and/or the second device discards information received from the second device or first device, respectively, during the wireless connection, in particular an advertising name, a name identifier and/or a static identifier, ensuring that the for the next connection, the second device may be chosen freely from a plurality of second devices and attempts to reconnect to the same second device are avoided.

### BRIEF DESCRIPTION OF THE DRAWINGS

Further advantages and features will become apparent from the description below and from the attached drawings to which reference is made and in which:

FIG. 1 shows a scanner system according to an embodiment of the disclosure in an unworn condition,

FIG. 2 shows the scanner system of FIG. 1 while worn by a user,

FIG. 3 shows main and scanning devices of scanner systems according to FIG. 1 in appropriate charging stations,

FIG. 4 shows a flow chart of a method according to an embodiment of the disclosure, and

FIG. 5 shows a flow chart of a method according to a second embodiment of the disclosure.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

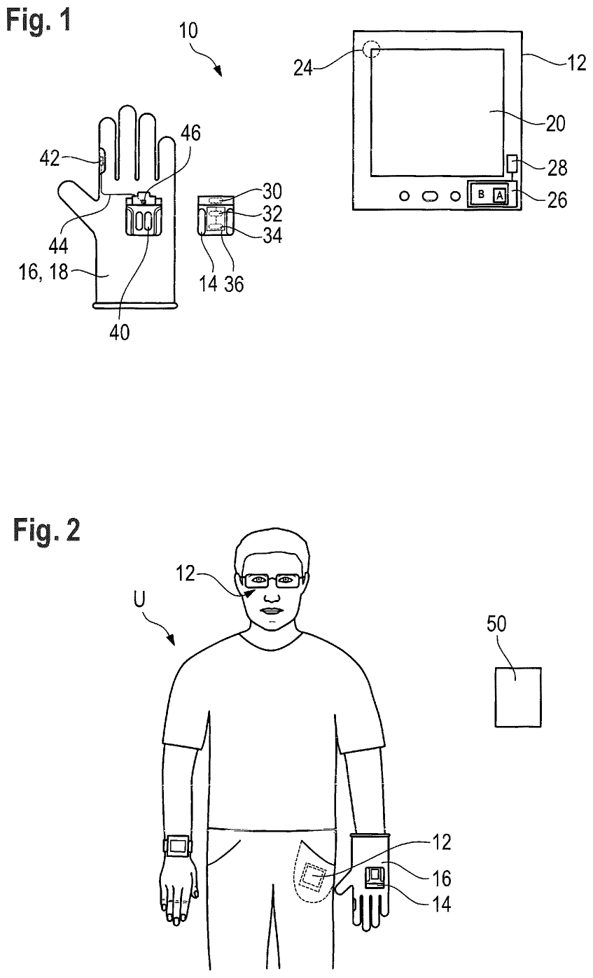

FIG. 1 shows schematically a scanner system 10 according to an embodiment of the disclosure comprising a main device 12, a scanning device 14 as well as articles of clothing 16, here a glove 18.

The scanner system 10 is configured for industrial use and therefore has a corresponding robustness for continuous operation.

The main device 12 is a smart device, for example a smartphone, a tablet or even a laptop. In particular, the main device 12 are smart glasses.

The main device 12 includes an optional display 20 as output means, an optional camera 24, a control unit 26 and a wireless communication module 28.

The main device 12 may comprise further output means, like lights, a speaker and/or a haptic engine like a vibration module.

The wireless communication module 28 is, for example, a Bluetooth module, i.e. configured for communication using the Bluetooth standard, in particular the Bluetooth Low Energy standard.

It is also conceivable that the wireless communication modules 28 make use of a different wireless standard, for example WLAN. In this case, the standard and protocols of the other wireless standard, e.g. WLAN, apply.

The control unit 26 has an operating system B on which an application A of the scanner system 10 is executed.

In the case that the main device 12 are smart glasses, the display 36 may be a self-illuminating screen in the area of the lenses of the glasses or a projection device which projects an image onto the lenses or somewhere else.

It is also conceivable that the main device 12 does not have a display or a connection to the Internet.

The scanning device 14 has a code reader 30, a control unit 32 and a wireless communication module 34. Optionally, the scanning device 14 can include a display 36 but may also be bare of a display.

The wireless communication module 34 is a, for example, Bluetooth module, i.e. configured for communication using the Bluetooth standard, in particular the Bluetooth Low Energy standard.

It is also conceivable that the wireless communication modules 34 make use of a different wireless standard, for example WLAN. In this case, the standard and protocols of the other wireless standard, e.g. WLAN, apply.

For example, the scanning device 14 does not have a connection to the Internet.

The scanning device 14 is in particular a dedicated device for reading codes and/or configured to automatically send information about the codes that have been read to the connected main device 12.

The code reader 30 is configured to read codes applied to objects. The code reader 30, also called scan engine, may be an optical code reader configured to read machine-readable codes, like barcodes, two-dimensional codes, for example QR codes, data matrix codes or the like, or any other optical machine-readable code.

It is also conceivable that the scanning device 14 has other sensors, such as an RFID reader, touch sensors or acceleration sensors in addition to or instead of the code reader unit 30. The display 36 can also include such sensors.

Within this disclosure, the term “code” is to be understood as any type of machine readable code, in particular optical codes, for example a barcode, a QR code, a data matrix code or suchlike, or RFID codes encoded in an RFID tag.

For example, the code reader 30 may be incompatible with the display 20 and other output means of the main device 12, in particular a display 20 of a smart glass. As such, the code reader 30 and the entire scanning device 14 are incapable of retrieving data and/or information from the main device 12 via its display 20 or its other output means. Data and/or information, in particular a name identifier or advertising name, cannot be communicated using the code reader 30 and the display 20 and other output means.

The scanning device 14 can be fastened to the body of a user U using the glove 18.

For this purpose, the glove 18 has a receptacle 40.

The glove 18 can also have an actuating element 42, for example a button for the scanning device 14.

By means of cables 44 and contact elements 46 in the receptacle 40, the actuating element 42 is connected to the scanning device 14 as soon as it is inserted in the receptacle 40.

The actuating element 42 serves as an input means for the scanning device 14 capable of actuating the scanning device 14.

The scanning devices 14 are thus so-called “wearables”.

FIG. 2 shows the user U wearing the scanner system 10.

The user U wears on his left hand the glove 18 with the scanning device 14 attached thereto. In his trouser pocket, the user U wears the main device 12 and/or the users wears the main device 12 at its head as glasses.

The user U is, for example, an assembly worker at a production line or a logistics employee in a warehouse.

At the beginning of a shift, the user U and each of his/her colleagues take a main device 12 and scanning devices 14 corresponding to his/her task from the corresponding charging stations 48.

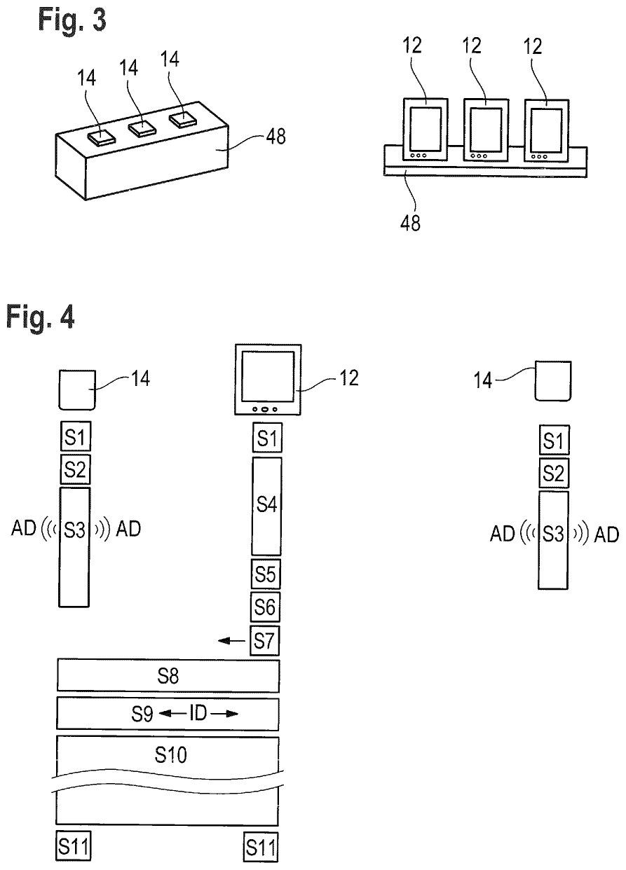

FIG. 3 shows charging stations 48 for scanning devices 14 and main devices 12, in which the main devices 12 and the scanning devices 14 are inserted for charging.

At the end of each shift at the latest, the user U puts the scanning devices 14 and the main device 12 back into the corresponding charging station 48.

In the charging station 48, the scanning devices 14 are not assigned to any of the main devices 12, so that the scanner systems 10 can be selected from any of the devices 12, 14. The user U can therefore take any main device 12 and any scanning devices 14 suitable for his task, drastically simplifying the selection process at a beginning of a shift.

In order to connect the scanning devices 14 to the main device 12 and thus to be able to use the scanner system 10, the scanning devices 14 must establish a wireless communication connection, for a example Bluetooth communication connection with the main device 12. To this end, the method according to FIG. 4 is carried out. The main device 12 and the scanning device 14, in particular their control units 26, 32 are configured to carry of the respective portions of the method.

FIG. 4 shows schematically a scanner system 10 with one main device 12 and two scanning devices 14 and a pairing diagram below the devices 12, 14 indicating the actions taken by the respective device during the method.

The scanning device 14 on the left-hand side is closer to the main device 12 than the scanning device 14 illustrated on the right-hand side.

In the example below and for illustration purposes only, the main device 12 is a first device and the scanning device 14 is a second device. It may as well be that the main device 12 is a second device and the scanning device 14 is a first device.

To connect the scanning device 14 to the main device 12, the user U starts the connection functionality on the scanning device 14 as well as on the main device 12.

For example, the user U starts the connection function of the application A on the main device 12 (S1).

It may be necessary for the method to be carried out to configure the main device 12 and/or the scanning device 14 to carry out the disclosed method. This may be done, for example, by transferring configuration information, e.g. a configuration file, to the main device 12 or the scanning device 14, respectively.

The file transfer may be initiated by the scanning device 14 by scanning a specific code, for example a code provided by a configuration tool running on a device not being the main device 12 or the scanning device 14. The configuration information is then transferred form a server to the main device 12 and/or the scanning device 14. In order for the scanning device 14 to receive the configuration information, it may have to be connected to the internet or a LAN via the main device 12. To this end, the scanning device 14 has to be connected with a main device 12, for example by using a connection method known in the art.

It is also conceivable that the connection function of main device 12 is always activated.

Further, it is conceivable that the connection function of the main device 12 is activated remotely, e.g. by the system control unit 50 and/or an API call.

In order to do so for the scanning device 14, the user U may actuate the actuating element 42, for example in a predefined manner.

The control unit 32 of the scanning device 14 may be configured to start the connection functionality if the actuating element 42 is depressed twice in short succession (similar to a double-click) and or if the actuating element 42 is depressed continuously for a predefined duration.

In addition or in the alternative, the connecting functionality of the scanning device 14 is activated if the scanning device 14 scans a connection function barcode, for example a barcode that includes, encoded therein, information and/or an instruction to the scanning device 14 to activate the connection functionality.

It is also conceivable that the connection function of the scanning device 14 and/or the main device 12 is activated automatically as soon as the device 12, 14 is removed from the charging station 48.

When the connection functionality is activated, the control unit 32 of the scanning device 14 determines the advertising name AD (S2). The advertising name AD may be determined in various ways depending on the configuration of the scanning device 14.

The advertising name AD may be received from the main device 12, e.g. by using the code reader 30 to scan a code provided by the main device 12. For example, the main device 12 shows a code on its display 20, wherein the code has encoded therein the advertising name AD.

The code may then be read by the code reader 30 upon actuation of the actuating element 42 when pointing the code reader 30 towards the display 20 of the main device 12.

The control unit 32 then obtains the advertising name AD from the code. Such a method has been described as part of a coupling scheme in US 2021/014910 A1.

In another possibility of determining the advertising name AD, the control unit 32 of the scanning device 14 determines the advertising name AD.

For example, the control unit 32 has stored therein or in an accessible storage a scheme for determining the advertising name AD based on a characteristic of the scanning device 14 itself. The characteristic of the scanning device 14 may be the serial number of the scanning device 14, a part of the serial number or the type of the scanning device and/or the type of the scanning device 14.

Instead of the characteristic, a name identifier may be used, wherein the name identifier has been received before.

For example, the name identifier has been received by the scanning device 14 by scanning a code having encoded there in the name identifier off the display 20 of the main device 12 in much the same way as the advertising name is received in the alternative discussed above.

The name identifier or the advertising name AD directly may also be received by the scanning device 14 by another way, for example by scanning a code displayed or printed on a device or object different from the main device 12.

It is also conceivable that the scheme for determining the advertising name AD is received from the main device 12 as explained with respect to the advertising name AD or the name identifier. The scheme may be defined in the name identifier. The scheme may also be received from an object or device different from the main device 12.

The scheme may define the structure of the advertising name AD. For example, the scheme may define that the advertising name AD has to include a portion being a specific static character string, i.e. one of one or more predefined strings of characters, and/or a portion having characters within a predefined range.

For example, the scheme may define that the advertising name AD has a first portion of seven characters being either the string “scnmod1” or the string “scnshrt” and a second portion of five characters being a string of integers between “00001” and “99999”. In this example, the first portion identifies the type of second device/scanning device 14 (e.g. “scanner model 1” or “scanner short range”, respectively) and the second portion are the last five digits of the serial number of the second device/scanning device 14, allowing identification of the individual device.

In yet another but simple alternative, the advertising name AD is the characteristic of the second device. For example, the advertising name AD is the serial number of the scanning device 14.

The advertising name AD may be determined by any of the above alternatives or a combination thereof.

Once the advertising name AD has been determined, at S3, the scanning device 14 advertises for connections using the determined advertising name AD. To this end, the Bluetooth wireless communication module 34 is controlled by the control unit 32 accordingly.

In particular, the advertising follows the requirements for advertising for connection as defined in the respective wireless standard, for example the Bluetooth standard, in particular in the Bluetooth low energy standard.

As such, the scanning device 14 is a discoverable device in the sense of the respective wireless standard, for example the Bluetooth standard.

At S4, the main device 12 searches for a scanning device 14 that advertises for connections, for example as soon as the connection functionality has been activated. To this end, the control unit 26 of the main device is configured to control the wireless communication module 28, e.g. the Bluetooth communication module, accordingly.

At S5, once an advertising signal of the scanning device 14 has been received, the main device 12, in particular the control unit 26 or the wireless communication module 28 of the main device 12, determines the received signal strength of the advertising signal received from the scanning device 14.

At S6, the received signal strength is compared to a strength cut-off limit by the main device 12, in particular its control unit 26.

To this end, the control unit 26 may have stored therein or in an accessible storage the strength cut-off limit.

The strength cut-off limit may be predefined and/or set manually.

It is also conceivable, that the strength cut-off limit is determined automatically, for example by the system control unit 50 of the scanner system 10.

The system control unit 50 may receive values of the signal strengths and occurrences of manual disconnection events right after pairing. Based on this information, the system control unit 50 determines the optimal strength cut-off limit value.

For example, if the strength cut-off limit value has been chosen too low, the following problems occur: At the beginning of a shift, when a plurality of users are trying to connect their scanning device 14 to their main device 12, misconnections occur. This means that the scanning device 14 of one of the users is connected to a main device 12 of another user. These misconnections are then manually resolved, which lead to manual disconnection events right after pairing. Thus, manual disconnection events may indicate that the strength cut-off limit should be increased.

It may also be possible that the strength cut-off limit is adapted by receiving an updated value from a system control unit 50 of the scanner system 10 or by an input of a user.

If there determined signal strength of the signals received from the scanning device 14 does not exceed the strength cut-off limit, no connection to this particular scanning device 14 is initiated by the main device 12.

For example, the signal strength of the signals received from the scanning device 14 on the right hand side of FIG. 4 does not exceed the strength cut-off limit so that the main device 12 does not initiate a connection with the scanning device 14 on the right-hand side. The scanning device 14 on the right-hand side thus continues to advertise (S3).

As the scanning device 14 on the left-hand side of the main device is closer to the main device 12, in the shown example, the determined signal strength of the signals received from the scanning device 14 exceed the strength cut-off limit. Thus, at S7, the main device 12, for example its control unit 26, initiates a wireless connection, for example a Bluetooth connection, for example by sending a connection request to the scanning device 14 on the left-hand side of FIG. 4.

The initiation of the connection with the scanning device 14 and the subsequent establishing of the wireless connection between the main device 12 and the scanning device 14 (at S8) is performed according to the connection process according to the respective wireless standard, for example the Bluetooth standard, called wireless connection process within this disclosure.

Establishing the connection is done, for example, by using the common configuration process (“handshake”) for wireless connections as laid out in the respective wireless standard, for example the Bluetooth standard.

In case that another scanning device 14 is close enough, so that the received signal strength would also exceed the strength cut-off limit, e.g. if the scanning device 14 on the right hand side of FIG. 4 were closer to the main device 12, the main device 12 would, at S7, initiate a wireless connection only with the scanning device 14, whose signals received by the main device 12 have the highest signal strength.

During configuration, a static identifier ID is for example exchanged between the main device 12 and the scanning device 14, for example the MAC address (Media Access Control address) of the scanning device 14 (S9).

The wireless connection between the main device 12 and the scanning device 14 is now fully set up and can be used for data transmission (S10).

During the intended use of the scanner system 10, the wireless connection is then maintained in accordance with the corresponding wireless protocol, in particular using the static identifier ID, even in case of shorter connection interruptions.

In an embodiment, during S1 to S10, the communication module 28 of the main device 12 is controlled by the application A, which thus controls the setting up of the wireless communication connection on the side of the main device 12.

More precisely, the application A directly controls the low-level parts of operating system B for controlling the communication module 28, for example the Bluetooth stack. This means that the high-level parts provided in the operating system B, which are originally intended for controlling the connection behavior and for automatic connection, are bypassed by the application A and are therefore not used.

In other words, only the application A—and not the high-level parts of the operating system B—knows the advertising name AD of the scanning device 14. In this way, the application A has the advertising name AD under control, as they are not permanently stored in the operating system B.

The static identifier ID such as the MAC address, is for example only kept during the presence of the wireless communication connection itself and only in the application A itself. The low-level parts of the operating system B which maintain the connection—i.e. the Bluetooth stack—are of course used for this purpose and receive the static identifier ID only for this purpose.

The application A may also prevent the main device 12 from seeking a connection with the scanning device 14 or other scanning devices using an advertising name other than the advertising name AD of the connected scanning device 14. Conversely, incoming connection requests using these advertising names AD are also rejected.

After the intended use of the scanner system 10 is completed, for example at the end of a shift, the wireless connection is no longer required and can be terminated, in particular automatically.

The wireless connection is automatically terminated, for example, if one of the devices 12, 14 does not receive activity requests from another device or from the user for a specified period of time. This is also called a timeout.

For example, the scanning device 14 automatically terminates the wireless connection if the user has not operated the actuating element 42 for a specified period of time or if no data has been received from the main device 12 for display on the display 36 for the specified period of time.

The wireless connection is also automatically terminated if one of the devices 12, 14 is inserted into the respective charging station 48 or connected to a charging cable. For example, if a scanning device 14 is inserted into the corresponding charging station 48, this scanning device 14 will automatically terminate the wireless connection with the main device 12. However, wireless connections between this particular main device 12 and other scanning devices 14 are maintained.

If the main device 12 is inserted into the charging station 48 or connected with a charging cable, all connections to scanning devices 14 are automatically terminated automatically, for example.

It is also conceivable that an existing wireless connection with a scanning device 14 is automatically terminated if another scanning device 14 is being connected.

For example, values can be specified for the number of scanning devices 14 per main device 12. If the specified number is exceeded, an existing communication connection is terminated when another scanning device 14 is being connected.

In addition or in alternative, an existing wireless connection may be terminated by the scanning device 14 or the main device 12, if the scanning device 14 scans a disconnect barcode, for example a barcode that includes, encoded therein, information and/or an instruction to the scanning device 14 and/or the main device 12 to terminate the wireless connection and/or to power down the scanning device 14.

During use of the scanner system 10, it is also conceivable that the main device 12, repeatedly determines the received signal strength of the signals received from the scanning device 14, and compares the signal strength to a disconnect strength cut-off limit.

The disconnect strength cut-off limit may be predefined and/or set manually. It is also conceivable that the disconnect strength cut-off limit is determined automatically, for example by the system control unit 50 of the scanner system 10.

If the signal strength of the signals received from the scanning device 14 coupled to the main device 12 falls below the disconnect strength cut-off limit, the main device 12 automatically terminates the wireless connection with this particular scanning device 14. The static identifier, the name identifier and/or the advertising name are then discarded as described below.

This way of terminating the wireless connection with a coupled device based on the received signal strength may also be carried out independently of how the main device 12 and the scanning device 14 had been coupled in the first place. Further, the second device does not need to be a scanning device 14. In particular, the main device 12 and the scanning device 14 may have been coupled by the method disclosed in US 2021/014910 A1 which is hereby incorporated by reference.

Upon or shortly after the termination of the wireless connection or the last existing wireless connection, the sending function of the communication module 28, 34 and also the receive function of the communication module 28, 34 is deactivated by the corresponding control unit 26, 32, in particular for scanning devices 14.

In scanning devices 14, the communication module 34 is thus only reactivated as soon as the connection functionality is activated.

It is thus ensured that devices 12, 14 which are not in use do not permanently attempt to establish a connection and thus occupy frequency ranges and interfere with communication connections between other devices.

If the wireless connection between a scanning device 14 and the main device 12 is terminated, the respective advertising name AD, name identifier and/or static identifier ID are discarded (S11). This may have been done already after the static identifier ID had been exchanged.

This means that on the side of the scanning device 14, the advertising name AD may be deleted.

On the side of the main device 12, this means that the application A also deletes the corresponding advertising name AD or otherwise prevents this advertising name AD from being used again. This can be done, for example, by correspondingly marking the advertising name AD or changing the storage location of the advertising name AD.

It is ensured that the corresponding advertising name AD is not used again to set up a wireless connection, as the advertising name AD or a static identifier ID were not stored in the operating system B. The corresponding advertising name AD is discarded at the latest before the next wireless connection is set up.

However, the advertising name AD and/or the static identifier ID is preferably discarded upon or shortly after the automatic termination of the wireless connection.

It is thus ensured that the main device 12 and the scanning devices 14 can no longer use information to reestablish a previous, terminated connection. In other words, by discarding the respective advertising name AD, the main device 12 and the scanning devices 14 forget which entity they were previously connected to, so that no misconnections or permanent assignments can occur.

It is therefore irrelevant which main device 12 and which scanning device 14 are removed from the charging stations 48 by the user U, because after removal from the charging station 48, all scanning devices 14 can be connected to any main device 12.

For a new setting up of a communication connection between the main device 12 and other or the same scanning devices 14, the procedure described above is repeated.

In the example above, the main device 12 has been the host of the wireless connection and the scanning device 14 has been the client of the wireless connection. The main device 12 is thus the first device and the scanning device 14 the second device.

It is also conceivable that the scanning device 14 is the host of the wireless connection and that the main device 12 this the client. In this case, it is the main device 12 that advertises for connections and it is the scanning device 14 that receives advertising names AD, compares the received advertising names AD with the strength cut-off limit, and also initiates the wireless connection.

In other words, the above procedures may also be performed with the scanning device 14 as the first device and vice versa.

Thus, the main device 12 would be the second device and the scanning device 14 would be the first device.

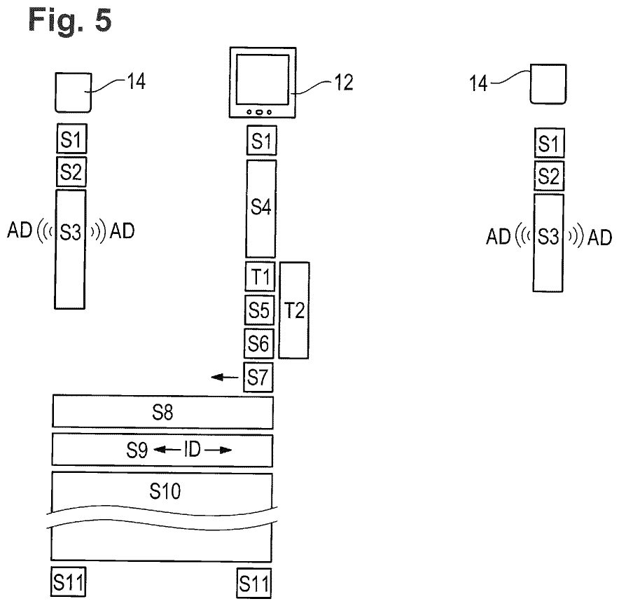

FIG. 5 shows a second embodiment of a method according to the disclosure substantially corresponding to the first embodiment shown in FIG. 4. Thus, in the following only the differences are discussed and the same and functionally the same components or actions are labeled with the same reference signs.

FIG. 5 corresponds to FIG. 4, wherein, before initiating a connection, the main device 12 checks a test condition.

To this end, the control unit 26 of the main device 12 has stored therein or on a storage accessible by the control unit 26, a test condition that has to be fulfilled in order for the main device 12 to initiate a connection with a scanning device 14.

Thus, after the advertising name AD of the scanning device 14 has been received by the main device 12, i.e. S4, the main device compares the received advertising name a with the at least one test condition at T1.

For example, the main device 12, in particular its control unit 26 has stored therein or in an accessible storage a name identifier which is compared to the received advertising name AD the as part of the test condition.

The name identifier may have been permanently provided in the main device 12, has been received from the system control unit 50 or has been inputted by a user.

The test condition may be that the received advertising name has been identical to the name identifier, that the received advertising name AD includes the name identifier anywhere in the advertising name AD or at a specific position within the advertising name AD.

For example, the advertising name AD is the serial number of the scanning devices 14 having 10 characters, and the test condition requires that the three-character name identifier is equal to the first three characters of the advertising name. This may be of use if only devices with a certain serial number—for example corresponding to a certain functionality—shall be used and thus connected to the main device 12.

The test condition may also be that the received advertising AD name follows the scheme, e.g. a scheme defined in the name identifier. In the example given above, it is checked whether the first seven characters of the advertising name AD are “scnmod1” or “scnshrt” and whether the following five characters of the advertising name AD are an integer between 00001 and 99999.

If, at T1, it has been determined that the received advertising name AD fulfills the at least one test condition, the main device 12 proceeds as in the first embodiment.

If the test condition has not been fulfilled, no wireless connection to this particular scanning device 14 is established. Alternative, if the test condition has not been fulfilled, a wireless connection may be initiated by a further trigger, but without a dependence on the signal strength. The trigger may be that the user U manually selects the individual scanning device 14 to establish a connection with using an interface of the main device 12, e.g. a touch-sensitive display.

The wireless connection is only initiated, as discussed in connection with the first embodiment, if the signal strength of the received signals from the scanning device 14 exceeds the strength cut-off limit.

The test condition may be checked simultaneously with the comparison of the signal strength of this strength cut-off limit or sequentially, e.g. before or after.

Another test condition, which may be checked instead or in addition to the test condition discussed above, depends on the change of the signal strength of the received signals from the scanning device 14.

In T2, the main device 12 repeatedly determines the received signal strength of the signals received from the scanning device 14 and records the received signal strength together with the time of reception of these specific signals.

Based on this record, the main device 12, in particular its control unit 26 determines based on the change of the signal strength over time whether the scanning device 14 closes in on the main device 12 or not. The test condition may then be, whether the scanning device 14 is closing in on the main device 12.

Only if the second test condition is fulfilled, the main device 12 initiates the wireless connection at S7. If the test condition is not fulfilled, the main device 12 does not initiate the wireless connection with the scanning device 14 even though the signal strength of the signals received from this particular scanning device 14 is above the strength cut-off limit.

By using these test conditions, the accuracy of pairing the main device 12 to the correct scanning device 14 is increased.

1. A method for operating a first device of a scanner system, the scanner system comprising a main device having a wireless communication module and a scanning device having a code reader and a wireless communication module, wherein the method comprises the following by the first device:
searching for a second device of the scanner system that advertises for connections,
determining a received signal strength of signals received from the second device,
comparing the received signal strength to a strength cut-off limit, and
initiating a wireless connection with the second device if the signal strength exceeds the cut-off limit.

2. The method according to claim 1, wherein the wireless communication modules of the main device and of the scanning device are Bluetooth modules, wherein the wireless connection between the first device and the second devices is a Bluetooth connection established using a Bluetooth connection process.

3. The method according to claim 1, wherein the first device determines the received signal strengths of signals received from more than one second device and initiates a wireless connection only with the one of the more than one second device whose signal received by the first device have a highest signal strength.

4. The method according to claim 1, wherein the first device comprises a control unit, the control unit having stored therein or in a storage accessible by the control unit a test condition, wherein the method further comprises:
receiving an advertising name from the second device by the first device,
comparing the received advertising name with at least one test condition by the first device, and
initiating a wireless connection with the second device if the received advertising name fulfills the at least one test condition and if the signal strength exceeds the cut-off limit.

5. The method according to claim 4, wherein the control unit of the first device has stored therein or in a storage accessible by the control unit a name identifier, wherein the test condition is based on the name identifier.

6. The method according to claim 5, wherein the test condition requires that at least one of the name identifier is identical to the received advertising name, the name identifier is included in the received advertising name, the name identifier is included in the received advertising name at a specific position of the advertising name, or the received advertising name follows a scheme defined in the name identifier.

7. The method according to claim 1, wherein the method comprises the following by the first device:
repeatedly determining the received signal strength of signals received from the second device and a time of reception,
determining, based on the received signal strength and the time of reception, whether the second device is closing in on the first device, and
initiating a wireless connection with the second device if it has been determined that the second device is closing in on the first device and if the signal strength exceeds the cut-off limit.

8. The method according to claim 1, wherein the method comprises terminating the wireless connection automatically, if at least one of the scanning device or the main device at least one of does not receive any activity request from another device or from a user for a predetermined period of time, is inserted into a charging station, is connected to a charging cable, a new second device is connected, scans a disconnect barcode, or the received signals strength of signals received from the second device coupled to the first device falls below a disconnect strength cut-off limit.

9. The method according to claim 1, wherein upon or after automatic termination of the wireless connection, the first device discards information received from the second device during the wireless connection.

10. A method for operating a scanner system, the scanner system comprising a main device, having a wireless communication module and a scanning device having a wireless communication module, wherein the main device or the scanning device is a first device, and the method comprises the following by the first device:
searching for a second device of the scanner system that advertises for connections,
determining a received signal strength of signals received from the second device,
comparing the received signal strength to a strength cut-off limit, and
initiating a wireless connection with the second device if the signal strength exceeds the cut-off limit.

11. The method according to claim 10, wherein the main device is a host of the wireless connection and the scanning device is a client of the wireless connection.

12. The method according to claim 10, wherein the strength cut-off limit is set manually or that the strength cut-off limit is determined automatically, in particular by a system control unit of the scanner system.

13. The method according to claim 10, wherein the second device advertises for connections using an advertising name based on a characteristic of the second device.

14. The method according to claim 13, wherein the characteristic of the second device is at least one of a serial number, a part of the serial number or a type of device of the second device.

15. The method according to claim 10, wherein the method further comprises by the second device:
receiving at least one of a name identifier or an advertising name, and
advertising for connections using the received advertising name or an advertising name based on the received name identifier.

16. The method according to claim 10, wherein the method comprises terminating the wireless connection automatically, if at least one of the scanning device or the main device at least one of does not receive any activity request from the other device or from a user for a predetermined period of time, is inserted into a charging station, is connected to a charging cable, a new scanning device is connected, scans a disconnect barcode, or the received signals strength of signals received from the second device coupled to the first device falls below a disconnect strength cut-off limit.

17. A scanner system comprising a main device, having a wireless communication module and a scanning device having a wireless communication module, wherein at least one of the main device or the scanning device is configured to carry out a method as a first device, wherein the method comprises the following by the first device:
searching for a second device of the scanner system that advertises for connections,
determining a received signal strength of signals received from the second device,
comparing the received signal strength to a strength cut-off limit, and initiating a wireless connection with the second device if the signal strength exceeds the cut-off limit.

18. The scanner system according to claim 17, wherein the main device comprises an output means, wherein a code reader of the scanning device is incompatible with the output means of the main device.

19. The scanner system according to claim 17, wherein at least one of the main device or the scanning device is bare of at least one of a display or a connection to the internet.

20. The scanner system according to claim 17, wherein at least one of the scanning device is a wearable device or the main device is a smart device.

21. The scanner system according to claim 17, wherein the scanner system comprises an article of clothing, which is designed to attach the scanning device to a body of a user.

22. The scanner system according to claim 17, wherein upon or after automatic termination of the wireless connection, at least one of the first device or the second device discards information received from the second device or the first device, respectively, during the wireless connection.
